(19) United States
(12) Patent Application Publication
(10) Pub. No.: US 2026/0127645 A1
(43) Pub. Date: May 7, 2026

(54) DISTRIBUTABLE AND FUNGIBLE CROSS-PLATFORM CONTENT CREDITS

(71) Applicant: Content Credits Inc., Covington, KY (US)

(72) Inventors: Adam Koehler, Cincinnati, OH (US); Vimalkumar Jayantibhai Patel, Mason, OH (US); Kathan Pravinbhai Patel, Saskatoon (IN)

(21) Appl. No.: 19/377,204

(22) Filed: Nov. 3, 2025

Related U.S. Application Data
(60) Provisional application No. 63/715,005, filed on Nov. 1, 2024.

(51) Int. Cl. G06Q 30/0601; G06Q 20/06

(52) U.S. Cl. CPC G06Q 30/0601; G06Q 20/06

(57) ABSTRACT

Methods and systems are described for a content credits system. A user may create a content credit account at a content credit server. When browsing the internet, the user may wish to access an article, video or other content but it prevented by a paywall. Rather than buy a subscription to get past the paywall, the user can use their previously purchased content credits. The content credits can be used to track views and purchases related to given content, ensuring better accounting and accurate payouts to content generators. A content credit server can also keep the information that a user has already purchased/accessed/unlocked the same article using content credits previously. This can allow the system to automatically unlock an article or other online content when a user returns to access it.

### CROSS-REFERENCE TO RELATED APPLICATIONS

This application claims priority to or is U.S. Application No. 63/715,005, titled “DISTRIBUTABLE AND FUNGIBLE CROSS-PLATFORM CONTENT CREDITS,” filed Nov. 1, 2024, which is hereby incorporated by reference in its entirety.

### TECHNICAL FIELD

The present disclosure generally relates to systems and methods for distributing and exchanging credits for creating and consuming online content.

### BACKGROUND

Consumers are increasingly consuming news and other content via social networks, such as X™ and Facebook™. Consumers are abandoning print media, such as newspapers and magazines. Many newspapers and magazines have attempted to survive in the online world by setting up paywalls and requiring subscriptions to access content. In an effort to lower costs, these same newspapers and magazines sometimes resort to AI (artificial intelligence)-generated content. The ubiquity of paywalls frustrates consumers, who often have no need for an annual subscription but wish to access a single article. The cost cutting in the newspaper and magazine industries makes it hard for article writers and other content generators to earn a living. So much content (e.g., via X) is available for free that it's hard for content generators to find effective ways to subsidize their work.

### SUMMARY

One version under the present disclosure comprises a content credit system. The system comprises a processor; and a memory storing instructions. The instructions can cause the processor to perform the steps of; receive one or more content from one or more content generators; provide an interface for one or more content servers to choose a selected one or more content for use; transmit the selected one or more content to the one or more content servers for display to one or more users; maintain one or more user accounts of content credit purchases for the one or more users; confirm login information related to the one or more user accounts when the one or more users wish to access the one or more selected content; deduct a selected amount of content credits from the one or more user accounts; and associate the selected amount of content credits with the one or more content generators, the selected one or more content, the one or more user accounts, and the one or more content servers.

Another version comprises a method performed by a content credit system. The method includes: receiving one or more content from one or more content generators; providing an interface for one or more content servers to choose a selected one or more content for use; transmitting the selected one or more content to the one or more content servers for display to one or more users; maintaining one or more user accounts of content credit purchases for the one or more users; confirming login information related to the one or more user accounts when the one or more users wish to access the one or more selected content; deducting a selected amount of content credits from the one or more user accounts; and associating the selected amount of content credits with the one or more content generators, the selected one or more content, the one or more user accounts, and the one or more content servers.

Another version comprises a method performed by a content credit system. The method comprises: detecting one or more content from one or more content generators; providing an interface for a user to input comments on the one or more content; displaying the comments and one or more comments of other users to the user via the interface; allowing the user to provide a selected amount of content credits to any of the other users for creation of the one or more comments via the interface; deducting the selected amount of content credits from a user account of the user; and associating the selected amount of content credits with the other users.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates one version of a content credit system under the present disclosure;

FIG. 2 illustrates one version of a user interface for a content credit system under the present disclosure;

FIG. 3 illustrates one version of a content credit system under the present disclosure;

FIG. 4 illustrates a flow-chart of a method version under the present disclosure;

FIG. 5 illustrates blockchain headers;

FIG. 6 illustrates one possible commenting layer version under the present disclosure;

FIG. 7 illustrates one possible commenting layer version under the present disclosure;

FIG. 8 illustrates one possible commenting layer version under the present disclosure;

FIG. 9 illustrates a flow-chart of a method version under the present disclosure;

FIG. 10 illustrates an exemplary project under the present disclosure;

FIG. 11 illustrates a possible method under the present disclosure for generating an aggregated web project.

FIG. 12 shows an example flow chart of training and inference pipelines for machine learning in accord with some versions under the present disclosure;

FIG. 13 shows a version of a neural network under the present disclosure;

FIG. 14 shows a version of a computing device for use in various versions under the present disclosure;

FIG. 15 illustrates a flow-chart of a method version under the present disclosure; and

FIG. 16 illustrates a flow-chart of a method version under the present disclosure.

### DETAILED DESCRIPTION

Before describing various versions of the present disclosure in detail, it is to be understood that this disclosure is not limited to the parameters of the particularly exemplified systems, methods, apparatus, products, processes, and/or kits, which may, of course, vary. Thus, while certain versions of the present disclosure will be described in detail, with reference to specific configurations, parameters, components, elements, etc., the descriptions are illustrative and are not to be construed as limiting the scope of the claimed versions. In addition, the terminology used herein is for the purpose of describing the versions and is not necessarily intended to limit the scope of the claimed versions.

There currently exist certain challenges in the realm of online content generation and content consumption. Consumers often have no need for a subscription to various sites, such as newspaper or magazine websites. But they may from time to time wish to read an article on such websites. If a user visits a website hoping to read an article, it is time consuming to explore or sign up for a subscription, and this can be expensive. But such users are likely to be willing to pay some amount of money for access to content. But the amount they are willing to pay is hard for website to discover. Relatedly, because it is hard for magazines and newspapers to make money in the online marketplace, article writers and other content generators have difficulty monetizing their output. There is a first delta between what consumers are willing to pay for articles/content and/or to websites, and what the websites want to charge. And there is a second delta between what websites are willing to pay content generators and what the content generators want to earn for their work. Another difficulty in the online marketplace is that consumers have difficulty keeping track of articles/content that they like, desire to consume, or wish to otherwise interact with.

Certain aspects of the versions disclosed herein provide solutions to these or other challenges. Certain versions include cross-platform content credits for both content generation and consumption. Certain versions include artificial intelligence (AI) and machine learning (ML) enhanced systems and methods for guiding content generators and/or websites for how to create and/or market their products. Certain versions can also assist in consumers in storing and/or tracking content they desire to consume or interact with, and in facilitating interactions between consumers and articles/content.

Certain versions may provide one or more of the following technical advantages. Versions can achieve greater tailoring of content generation and/or marketing to consumers most likely to consume such content. Certain versions can collect large amounts of data to help in optimizing future content by style, industry, consumer preference, and/or other factors. Versions can achieve quicker price discovery mechanisms, finding prices that are acceptable to both consumers and websites, and between content generators and websites, and/or between other parties in the online marketplace.

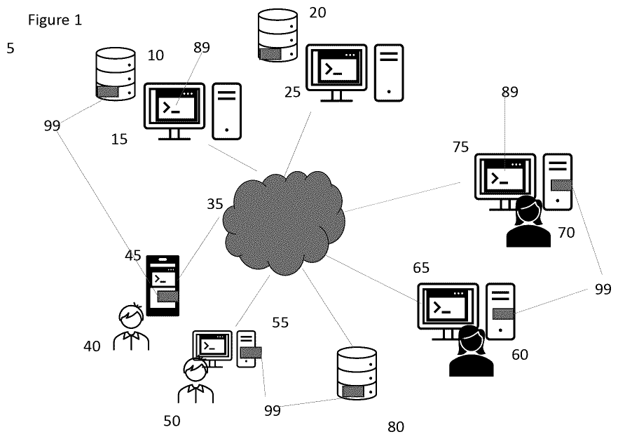

Referring now to FIG. 1, one version of a content credits system 10 is shown. Consumers 40, 50 can access network 35 (e.g., Internet, cellular, Bluetooth™, Wi-FI, satellite, enterprise, private network, similar networks, or combinations of the foregoing) via computing devices 45, 55 (e.g., computers, tablets, mobile devices, etc.) to view content 89. Content server(s) 10, 20 may offer websites 15, 25 (e.g., online newspapers, magazines, video sites, mobile applications, or other types of online content) containing content 89 for access via network 35. Content generators 60, 70 (e.g., writers, posters, videographers, etc.) may provide content 89 for use on websites 15, 25. Content generators 60, 70 may use computing devices 65, 75 to create, transmit, edit or otherwise manipulate content 89. Content credit server(s) 80 may provide functionalities as further described herein with respect to cross-platform content credits. Any or all of content servers 10, 20, computing devices 45, 55, 65, 75 and/or content credit servers 80 may comprise AI/ML engine(s) 99. AI/ML engines 99 may comprise AI/ML functionality as described further herein.

In a typical use-case scenario, consumers 40, 50 may browse the internet and run into a paywall to access content 89 (e.g., an article or video produced by a content generator 60, 70). Typically, the consumer will face a paywall pop-up or login screen requiring an account or subscription with the respective website. But the cost of a subscription likely outweighs the value of e.g., reading the one desired article of content 89. Under certain versions of the present disclosure, a separate pop-up, separate option in the first pop-up, or browser extension, or mobile application provided by content credits server 80 can be presented to consumers 40, 50. A separate pop-up, separate option in the first pop-up, browser extension, or mobile application provided by content credits server 80 can be integrated with a browser of consumers 40, 50 and may allow for commenting, social media posts, or other means of interacting or commenting by consumers 40, 50 with content 89.

Consumers 40, 50 can sign up for an account with content credits server 80. This account can offer the consumers 40, 50 the chance to purchase or earn cross-platform content credits. These content credits can be used to purchase or access content at compatible websites. Content credits could be any useful unit of measurement (e.g., US dollars or cents, a proprietary credit, units, numbers of articles, numbers of videos, or other types of measurements). A variety of newspaper or magazine websites can also register with content credits server 80. In some versions, newspapers or magazines may be able to set their own price (e.g., in dollars or other types of credits), or in other cases there may be a set value for each content.

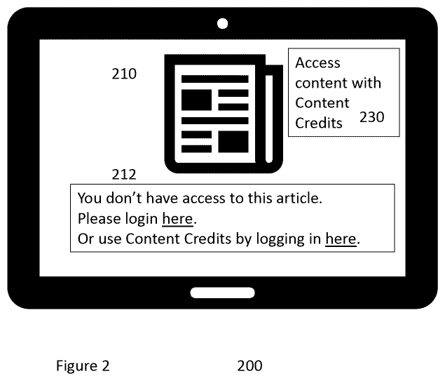

In a typical use-case under the present disclosure, when consumer 40, 50 attempts to access content 89 offered by content server 10, they may hit a paywall (e.g., a paywall popup, or other internet user interface). For example, see web interface 200 of FIG. 2. A user may wish to access content 210 (such as an article). Paywall message 212, either as a popup or within web interface 200. Content credit server 80, which may track consumer accounts, may allow consumers 40, 50 to pay or use a credit for a one-time access or download of the desired content. Content credit server 80 may allow this by various means. For example, the user may be able to login within paywall message 212 of FIG. 2. Alternatively, browser extension 230 may notify the user that content credits can be used to access content 210. The cost (e.g., in credits or dollars or other units) may be set by the publisher of content 210, or content credit server 80, or via other means. In other scenarios, a user can log in to a website with their content credit account. In such scenarios, the browser/website may automatically detect if credits were purchased by the user, and automatically unlock a desired article.

Referring again to FIG. 1, certain versions of the present disclosure can allow for tracking and data analysis with regards to e.g., content 89 generated by content generators 60, 70. In one example version, content generator 60 may upload content 89 onto content credits servers 80. Content 89 may then be made available to managers of content servers 10, 20 and websites 15, 25. One website 15 may desire to publish content 89, in which case content credit server 80 can facilitate e.g., the negotiation/bidding/sale of content 89 from content generator 60 to website 15. Content 89 is then published on website 15. When consumers 40, 50 attempt to access content 89, they may use content credits to access the content 89. Payment to content generator 60 could be a flat fee. Or it could be per view/download. In this case, content credit server 80 can track how many content credits have been paid to view content 89. Thus an accurate accounting of views can be used to provide payment to content generator 60.

Besides accurate accounting for payment, data tracking and analysis can be achieved by content credits server 80. With respect to a given content 89, content credits server 80 can track various data, such as: downloads, views, geographic location of views, types of devices used to access content 89, information about consumers 40, 50 (e.g., age, gender, browser type, mobile device type, browser history or preferences, identifying data such as email or contract information, or other types of data that may be stored or tracked by or via various browser or device systems or technologies such as cookies or tags). In certain versions, data tracking and analysis as described herein can be performed by content credits server 80. But in other versions, web servers 10, 20, computing devices 45, 55, 65, 75, may perform or assist in the data tracking and analysis. Various groupings of the foregoing devices may perform the data tracking and/or analysis systems or methods described herein.

In certain versions data tracking and analysis aspects can be leveraged to assist content generators 60, 70 and websites 15, 25 of FIG. 1. For example, content generators can be presented with data on what types of articles can generate the best income or return. Examples of data could include, e.g., best websites to sell to, topics of most interest to readers/viewers, optimal length of article, sentence length, type of vocabulary, best words for titles, video length, types of music to include in videos, types of graphics to include in articles, trending news data (e.g., trends data from Google™ searches, X™ posts, or other sources) or other various data that may assist in making content more desirable by the public. This or other data can be presented to website managers as well. Other data, such as what writers/generators sell best, may be more useful for the website manager.

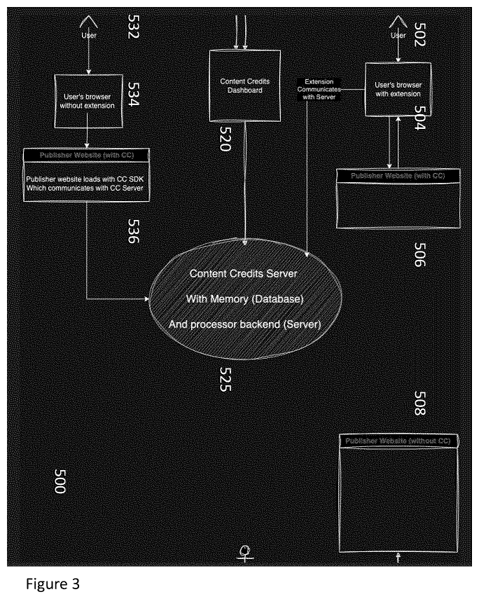

FIG. 3 displays another version of a content credit system 500, similar in some ways to content credit system 10 of FIG. 1. FIG. 3 illustrates two possible versions for users 502, 532 to access online content. User 502 uses a browser 504 with an extension (e.g., a Google Chrome Extension or similar types of applications that integrate with browsers). Or user 532 can use a browser 534 without a browser extension to access a publisher website 536. Content credits server 525 stores the data about which users 502, 532 has access to which article or other online content. Also, content credits server 525 holds the information about credits balance of a particular user 502, 532. Content credits server 525 can expose APIs (application programming interfaces) that allow SDKs (software development kits) and extensions to check access of articles, check authentication, check credit balance etc.

In one scenario, user 502 can use browser 504 to access publisher website 506, which is integrated, or has an account with, content credits server 525. In this scenario, browser 504 uses an extension to interface with content credits server 525 and check an account belonging to user 502 and interoperability with website 506. Here, the website 506 will use the token stored in the extension's local storage. A SDK (previously provided by content credit server 525) at website 506 will communicate with the extension and the extension will communicate with content credit server 525. An advantage of this scenario is that the user doesn't have to login with a popup on every publisher's website 506, 536 to get that cookie.

In the other scenario of FIG. 3, user 532 accesses website 536 with a browser 534 without an extension. Here publishers of website 536 will install an SDK. The SDK handles the communication directly with the content credits server 525. It can use a cookie stored in the browser 534 and shares that with the content credits server 525 to check for article access, purchase article options, etc.

Content credits dashboard 520 may be useable by managers of content credits server 525 to adjust settings. Alternatively, users 502, 532 may access content credits dashboard 520 (e.g., via browsers 504, 534) to purchase content credits, change account settings, etc. In some cases, an extension in browser (such as browser 504) may be operable for users to purchase credits, change account settings, etc.

Certain versions of system 5 of FIG. 1 or 500 of FIG. 3 can include e.g., an interactive dashboard presented to content generators 60, 70 for submission of content. The interactive dashboard can also be presented to website managers to view possible content for use on their websites 15, 25. The interactive dashboard can present varied data tracking and analytics as described in various versions herein. Different parties may have to pay to access system 5 or an interactive dashboard. For example, websites 15, 25, or content generators 60, 70 may have to pay a subscription fee to participate in the system 5.

In certain versions content servers 10, 20 can comprise data sources for the data tracked in relation to content. For example, content server 10 can provide news or social media trend data. Or data sources such as Wikipedia or LLM (large language models) may provide data.

Certain versions may incorporate blockchain or distributed ledger technology. In addition, certain versions may incorporate AI/ML aspects.

### Blockchain Versions

Certain versions can integrate blockchain or distributed ledger functionality (generally referred to as blockchain for the present disclosure). For example, blockchain can be incorporated as a means to provide accounting benefits with regard to tracking content provided by content generators 60, 70 of FIG. 1. For example, when a content generator 60, 70 uploads content to e.g., system 5 or content credits server 80 via interactive dashboard, a token can be created that comprises the content, e.g., content 89. The content 89 may then be purchased or licensed by website 25 and published there. Consumers 40, 50 may then consume content 89, paying content credits for access. During this whole process the token comprising content 89 can collect some, most, or all of this data. As more and more data is collected related to content 89, the more valuable the token becomes. The data included in, or appended to, the token can comprise any data that can be tracked or analyzed with regard to the content, content generators, websites, users/consumers, or other data. Benefits of the token include greater collection of data, but also accurate accounting for tracking license fees, payments to generators or websites, or other accounting uses. If content servers 10, 20 provide data used in the data tracking and analytics process, then they may receive payments as well. For example, a content generator 60, 70 could comprise a LLM that desires to ingest large amounts of data. Part of its content generation process could comprise using interactive dashboard to access various content servers 10, 20, ingesting that data, tracking these transactions via an associated token, and ensuring payment to each involved party. Accordingly, in certain versions content generators 60, 70 and content servers 10, 20 can play similar roles. In any given version, a single entity (e.g., content generator 60) can be both a content generator and/or content server. The associated tokens of a blockchain can track the transactions and ensure payment for associated uses. One challenge currently is that LLMs are scanning and scraping large amounts of web content, and potentially infringing copyright laws. If an LLM operator joins e.g., system 5 of FIG. 1, and blockchain transactions are implemented as described to track content and use thereof, then system 5 can help ensure that content generators 60, 70, and/or content servers 10, 20 are paid when scraped or otherwise utilized by LLMs or other AI/ML tools.

In some versions, a computing device (e.g., content servers 10, 20, computing devices 45, 55, 65, 75, etc.) with LLM/AI/ML functionality may be scraping large amounts of data from various internet sources (e.g., other components such as content servers 10, 20, computing devices 45, 55, 65, 75, etc.). In some situations, the scraping computing device has not officially joined e.g., system 5 of FIG. 1. In such scenarios, system 5 can detect the scraping and may be able to detect what entity(ies) or computing device(s) is doing the scraping, and can invoice the entity(ies) or device(s) on behalf of the parties/devices being scraped. In scenarios where the scraping computing device is not part of e.g. system 5 of Figure, and is not a member of an associated blockchain, then detecting such scraping and charging the offending entity/device may not take place via a blockchain/DLT. In these situations, detecting scraping may comprise additional functionality. Some examples include:
Analyzing Traffic Patterns:
   a. Unusual Request Volumes: Bots tend to make a high number of requests within a short period, exceeding typical human browsing patterns.
   b. Rapid Navigation & Interaction: Bots often interact with pages at unnatural speeds and follow predictable paths, unlike the more varied actions of human users.
   c. Anomalous Spikes or Drops in Traffic: Sudden, unexpected changes in traffic volume can indicate unusual activity, including scraping or other bot activities.
   d. Requests for Obscure or Non-Existent Resources: Scrapers that crawl an entire site may attempt to access pages that aren't typically visited by humans, or even non-existent resources.
IP Address Analysis:
   a. Excessive Requests from a Single IP: Repeated requests from the same IP address can be a strong indicator of scraping activity.
   b. IP Reputation Services: Tools and services can help identify IP addresses associated with known malicious activity or botnets.
   c. Use of Hosting IPs or Corporate IP Ranges: Scrapers often utilize hosting company IP addresses or corporate IP ranges to distribute their requests, which can be flagged.
   d. Geolocation Mismatch: Receiving traffic from geographic locations that don't align with expected user locations can be a red flag.
User Agent Analysis:
   a. Generic or Default User-Agent Strings: Scrapers may use default or outdated user-agent strings associated with scraping tools, making them easier to identify.
   b. User-Agent Strings That Don't Align with Normal Traffic Data: User-agent strings that don't match typical browser patterns can indicate automated activity.
Behavioral Analysis:
   a. Mouse Movements & Typing Patterns: Analyzing user behavior, such as mouse movements and typing speed, can reveal anomalies that suggest bot activity.
   b. Session Duration: Bots may have unusually short or long session durations compared to human users.
   c. Navigation Flow: Observing how users navigate the website can highlight strange sequences or bypasses that suggest bot activity.
Technical Verification:
   a. CAPTCHAs and Bot Challenges: Implementing CAPTCHAs or other bot challenges can help differentiate between humans and bots.
   b. JavaScript and Cookie Verification: Bots that cannot execute JavaScript or handle cookies properly are often easier to detect.
   c. Honeypot Traps: Hidden elements on a webpage invisible to humans but visible to bots can alert the website to scraper activity when interacted with.
AI/ML
   a. Identifying Patterns in Large Datasets: Machine learning models can analyze large datasets of traffic to identify subtle patterns that differentiate normal user behavior from bot activity.
   b. Adaptability to Evolving Bot Behaviors: ML algorithms can learn and improve over time, adapting to new scraping techniques and patterns.
Other Methods:
   a. Account Analysis: For sites requiring authentication, examining account names and email addresses can help identify scrapers, especially those creating fake accounts.
   b. DNS Analysis: Using reverse DNS lookups can help identify the entity behind a scraper by finding the domain name associated with its IP address.
   c. Website Redesign: Designing websites to limit data exposure can reduce unwanted scraping activity.

The preceding tactics can be implemented by system 5 or various components within system 5, e.g., content servers 10, 20, computing devices 45, 55, 65, 75, and/or AI/ML engines 99.

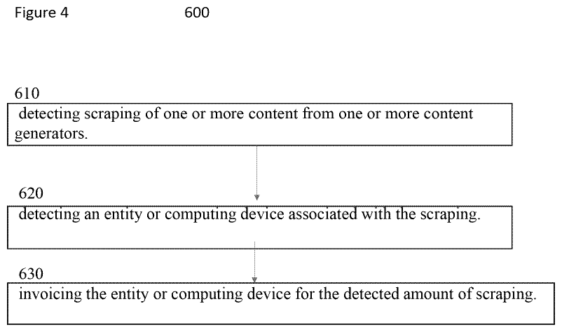

FIG. 4 illustrates one possible method version under the present disclosure. Method 600 comprises a method performed by a content credit system. Step 610 is detecting scraping of one or more content from one or more content generators. Step 620 is detecting an entity or computing device associated with the scraping. Step 630 is invoicing the entity or computing device for the detected amount of scraping. Method 600 can comprise a variety of additional, alternative, and/or optional steps. For example, in certain versions the detecting scraping comprises one or more of: analyzing traffic patterns; IP address analysis; user agent analysis; behavioral analysis; technical verification; AI/ML analysis; detecting changes to a blockchain or DLT.

The blockchain utilized in certain versions can differ, with options including Bitcoin, Ethereum, and others. Various distributed ledger technologies (DLTs) may be employed. Below is a description of general DLTs, including different blockchains like Bitcoin. However, those skilled in the art will understand that these principles apply broadly to various distributed ledgers. DLTs, such as blockchains, serve as public ledgers for all transactions executed on a network of participating nodes. Keeping a public record of transactions allows for validation and protection against issues like double spending without needing a trusted third party (e.g., a bank). Some definitions, such as below, tend to apply across most DLTs.

Input: The input to a transaction input comprises three key elements: Transaction Identification (ID): A unique identifier for the transaction; Output Index: This refers to the specific index number of the output being utilized by the sender. It points to a previous transaction's output that is now being spent; and Input Script: A piece of code that provides the necessary information to validate the spending of the referenced output. These components collectively form the input structure, allowing the system to trace and verify the flow of assets or data within the distributed ledger.

Output: The transaction output can be described as the transfer amount along with the additional components such as change amount or transaction fees. Transfer amount represents the quantity of cryptocurrency (such as Bitcoin or Ethereum) being sent to the recipient. The output also includes any change amount returning to the sender and/or transaction fees. Each output is assigned a unique index number, which serves as a reference point when this output is later used as an input in a subsequent transaction. The output structure typically comprises two main parts: the amount of cryptocurrency being transferred, and the output script, which contains instructions for spending the transferred amount. This structure enables the tracking and verification of cryptocurrency movements within the blockchain network, ensuring the integrity and continuity of transactions.

Transaction: A transaction in a distributed ledger or blockchain can be described as a composite of several elements. Transaction Version Number: Indicates the set of rules this transaction follows. Input: Details of the source of the funds or data being transferred, as described above. Output: Specifies the destination and amount of the transfer, such as described above. Receiver's Hashed Public Key: A cryptographic representation of the recipient's address. Sender's Full Unhashed Public Key: Corresponds to the public key hash of the unspent transaction being utilized. Sender's Signature: Created using the sender's private key, this verifies the authenticity of the transaction. Each transaction is assigned a unique identifier within the DLT/blockchain system. This identifier is generated by applying a hash function to the entire transaction data, resulting in a distinctive cryptographic fingerprint for each transaction.

Genesis Block: The Genesis Block is the inaugural block of a blockchain, typically designated as block number 0 and embedded into the software. Created by Bitcoin's founder, Satoshi Nakamoto, this first bitcoin block includes a transaction that allocates 50 bitcoins to a specific address.

Coinbase transaction: A coinbase transaction is a unique type of transaction in a blockchain block that generates new cryptocurrency. This transaction rewards the miner of the block with a specified amount of cryptocurrency (e.g., currently 12.5 bitcoins) and includes the transaction fees from all transactions within that block.

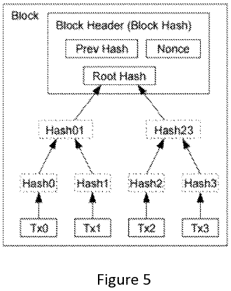

Bitcoin employs a stack-based scripting system for transaction processing. This system operates as follows: Output Script: Contains the receiver's hashed public key and machine-level validation codes. These codes are used when the recipient later spends the received coins. Input Script: Includes the sender's signature and full unhashed public key. Transaction Hashing: When transactions are prepared for inclusion in a block, they undergo a hashing process, e.g., in bitcoin to create a Merkle root. This method conserves storage space. Merkle root creation involves: transactions in the block are paired and hashed, the resulting hashes are then paired and hashed again, this process continues until a single hash value remains, known as the Merkle root. The Merkle root creation process is visually represented in FIG. 5. This structure allows for efficient verification of transactions within the Bitcoin network while minimizing data storage requirements.

Block: A block in a blockchain consists of two main parts: the block header and the block body. The block header typically includes a block version (indicates the set of block validation rules to follow), previous block header hash (links to the previous block, creating the chain), transaction root (e.g., Merkle root in Bitcoin, a single hash representing all transactions in the block), timestamp (when the block was created), target bits (a threshold value for the block header hash, determining mining difficulty), nonce (variable used in the mining process to find a valid block hash). The block body typically includes transaction count (the number of transactions included in the block), transactions (the full list of transactions in the block). The target bits in the header set a maximum value for the block's hash. To successfully mine a block, miners must find a nonce that, when combined with other header data, produces a hash value below this target. This mechanism controls the difficulty of block creation in the blockchain network.

Address: The address of a user is an encoding of several values. In the context of bitcoin, a user's address is a complex encoding of multiple elements: version, indicating the address format; Hash160 of the public key, creating a compressed form of the user's public key; checksum, to ensure the integrity of the address. These components are combined and encoded using Base58, a binary-to-text encoding scheme. The checksum is derived from the hashed public key, applying the SHA256 algorithm twice to the hashed public key, and the first four bytes of this double-hashed result become the checksum. Hash160 generation can begin with the user's public key, the SHA256 hash is applied to the public key, and RIPEMD160 hash is applied to the result of the SHA256 hash. This multi-step process creates a unique, secure, and verifiable address for each user in the bitcoin network, balancing the needs for brevity, security, and error detection.

An overview of how bitcoins are exchanged using the underlying blockchain concept is helpful when considering how content (e.g., content 89 of FIG. 1) can be tracked with crypto/blockchain versions as described herein.

A bitcoin transaction process can be summarized as follows:
Initiation: At initiation the receiver generates a public/private key pair and shares their bitcoin address with the sender, and the sender creates a transaction, signing it with their private key.
Broadcasting and validation: The signed transaction is broadcast to the network and nodes in the network validate the transaction.
Spending received coins: To spend received coins, the receiver publishes their full public key and signs the new transaction. If the receiver loses their secret key, they cannot spend their unspent transaction outputs (available balance).
Decentralized verification: All transactions go through decentralized verification. Without a central authority, network nodes perform validation. A transaction is accepted when a majority of nodes verify the signature and confirm:
   a. The sender owns the bitcoins being transferred.
   b. The bitcoins haven't been used in a previous transaction.
Proof of Work (PoW): Nodes compete to create new blocks by finding a nonce value. The nonce, combined with the previous block's hash and new transactions, must produce a hash below a target threshold. Successful miners are rewarded with newly generated bitcoins (coinbase transaction).
Timestamping and Chain Building: Transactions are timestamped by including them in the ongoing chain of hash-based proof of work. The difficulty of the proof is periodically adjusted based on block generation rate.
Security Against Double Spending: Modifying a transaction would require recreating its block and all subsequent blocks. This is computationally infeasible as long as honest nodes control the majority of the network's processing power.

This system ensures secure, decentralized transactions without the need for a trusted third party, relying instead on cryptographic proof and network consensus. By tying each content, and each use thereof, to a block or cryptocurrency, the lifecycle of content can be tracked, with immutable accounting records by which each party can be billed/paid appropriately.

### Commenting Layer Versions

Certain versions can facilitate commenting by users across various domains, articles, content, and social media. Certain versions can comprise a “floating social layer” that overlays third-party publisher content. Versions can enable users to comment freely but also allows others to tip commenters with credits using the described micropayments system.

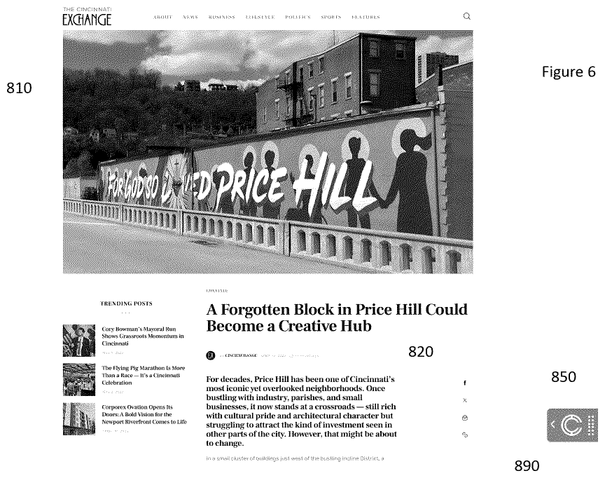

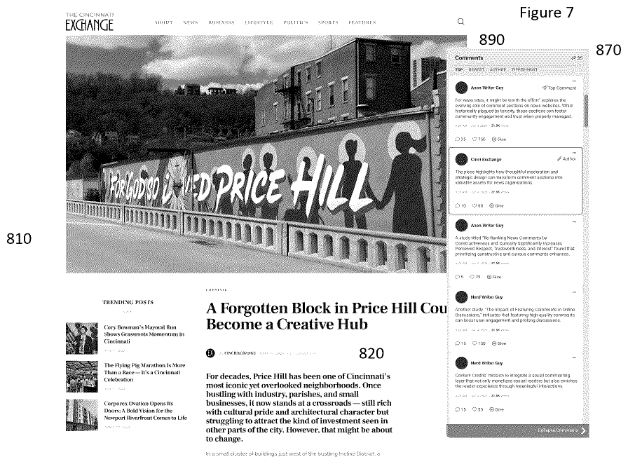

FIGS. 6 and 7 illustrate possible versions of commenting layer functionality. Website 810 can display content 820 (here, an article, but which could comprise social media post(s), video(s), article(s), audio(s), etc.). Collapsed tab 850 can comprise a browser extension or other software or application that “sits” on top of the content 820. Collapsed tab 850 can provide a discreet entry point for users to view or participate in a comment section without publisher integration or permission. Some publishers have gotten ride of comment sections due to e.g., costs of moderating comments sections, unruly commenters, copyright claims, or other reasons.

In FIG. 7, collapsed tab 850 has been expanded into comment “drawer” 870 with comments 875. Comment drawer 870 can offer several functionalities, including: commenting; likes vs. monetary tipping (“Give”); visual indicators for top comments and author comments (shown in green outline); sorting tabs (e.g., Top, Newest, Author, Tipped Most). Comment drawer 870 and collapsed tab 850 can generally be referred to as commenting layer 890, which may be a mobile application, browser extension, desktop applications, other software, combinations of the foregoing, etc.

Commenting layer 890 may be integrated and combined with other versions described herein. For example, content 820 of FIGS. 6 and 7 may be behind a paywall and must be unlocked with credits first, such as described above in regard to other versions. Commenting itself may be free. Users can tip valuable commenters directly using content credits, such as those which may be used to consume content, as described above in regard to other versions.

Commenting layer 890 can bring value to website 810 and/or the creator of content 820. For example, commenting layer 890 could drive traffic back to the site more than once. User may want to see and reply to comments on their comments, etc. Multiple visits can boost advertising revenue.

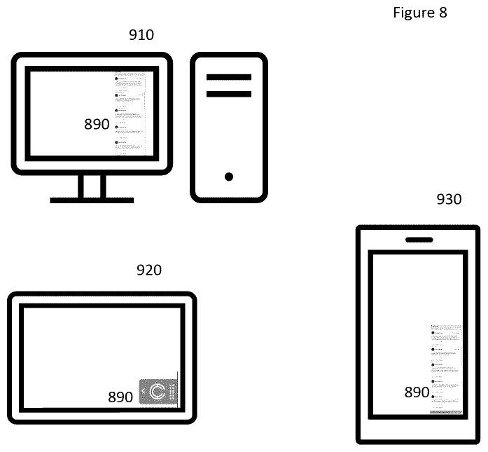

Commenting layer 890 can “sit” on top of a variety of content providers: The New York Times™, YouTube™, X™, etc. Commenting layer 890 can also be used by users across a variety of devices, such as devices 910, 920, 930 shown in FIG. 8.

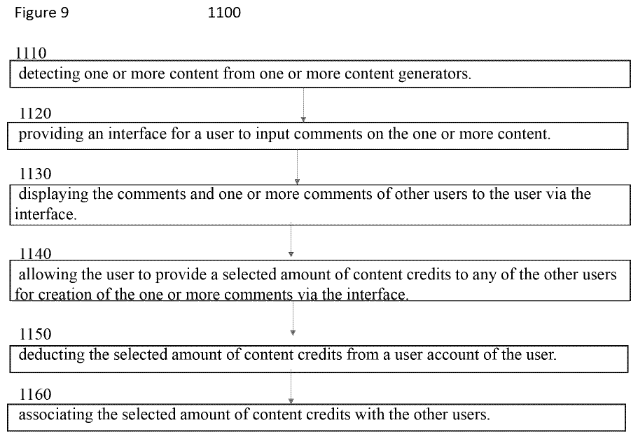

FIG. 9 illustrates a possible method version under the present disclosure. Method 1100 comprises a method performed by a content credit system. Step 1110 is detecting one or more content from one or more content generators. Step 1120 is providing an interface for a user to input comments on the one or more content. Step 1130 is displaying the comments and one or more comments of other users to the user via the interface. Step 1140 is allowing the user to provide a selected amount of content credits to any of the other users for creation of the one or more comments via the interface. Step 1150 is deducting the selected amount of content credits from a user account of the user. Step 1160 is associating the selected amount of content credits with the other users. Method 1100 can comprise a variety of additional, alternative, and/or optional steps.

### Web Project Versions

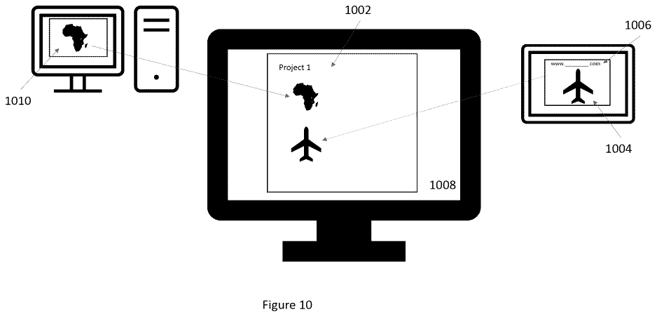

Web users often use disparate sources to inform planning of projects like vacations, events, activities, etc. This process typically includes the user collecting a multitude of links to webpages if they want to remember particular information from the site. This alone can lead to the user forgetting the information they wanted to store because the link only takes them to the page, not the particular information. Sometimes, a user may collect screenshots or copy and paste elements from a webpage, but may lose the link to the actual information preventing the user from finding the broader context in which the information was presented. FIG. 10 illustrates an exemplary project 1002 for planning a vacation. The project 1002 may be viewable within a web browser 1008. A user visit a web address 1006 and want to save flight information 1004 to the project 1002. The web address 1006 may be hidden within the project 1002, but easily accessible upon user request. Similarly, a user may want to save destination information 1010 from a separate webpage to the project 1002. The project 1002 may display the desired flight information 1004 and the destination information 1010 without any extraneous information while storing and maintaining potentially useful data related to the desired destination information 1010 and/or desired flight information 1004. This potentially useful data may include time accessed, web page link, etc.

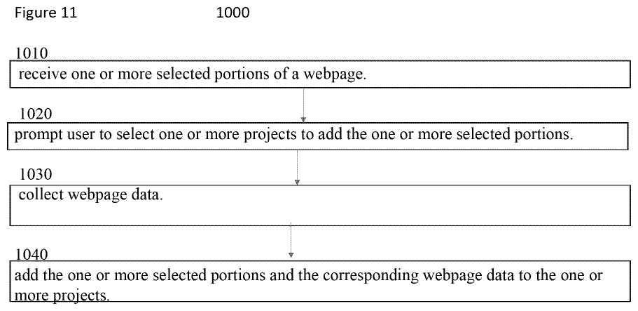

FIG. 11 illustrates a possible method 1000 under the present disclosure for generating an aggregated web project. In this method 1000, a user may select one or more portions of a webpage that are received 1010 by a system capable of performing the method 1000. The system then prompts 1020 the user to select one or more projects to add the one or more selected portions of the webpage. The user may select one or more previously open projects and/or may open a new project. These projects may be stored within an internet browser such that the browser provides a shortcut the user can click that will take the user to an in-browser page that displays all of the webpage portions that the user has added to the project. In some versions, the in-browser page display may allow the user to manipulate the webpage portions within the in-browser page.

The system may then collect 1030 webpage data from the host webpages from where the one or more selected portions originate. This collection 1030 may include scraping the webpage for contextual data, storing the webpage link, and/or other data collection. Then the system may add 1040 the one or more selected portions along with the webpage data corresponding to each of the one or more selected portions to the one or more projects. In some versions, the corresponding webpage data may be stored as metadata of the one or more portions while still accessible to the user upon request while in some versions the corresponding webpage may be displayed along with the one or more portions.

### AI/ML Versions

Various versions under the present disclosure can incorporate AI/ML functionality. For example, for purposes of the present disclosure, content servers 10, 20, computing devices 45, 55, 65, 75 and/or content credit servers 80 of FIG. 1 can be said to comprise an AI/ML engine 99, either separately or together. Each component may comprise a separate instance of an identical AI/ML engine 99. Or a “central” AI/ML engine 9 could be running at any location, such as credit content server 80, and others of the foregoing devices could function like an output/input interface to the central AI/ML engine 99, allowing user input, data collection, user interface for a user, etc. As content 89 is created and distributed in system 5, AI/ML engine 99 may collect data about content 89 itself, or general market data and customer data. For example, data collected could include e.g.: number of words in an article, types of words used in titles, length of videos, customer background or purchasing data, marketing data from third parties such as Google Ads, Facebook, X, etc., social media metrics, stock market data, customer ratings or feedback about content 89, and a variety of other data. Certain or all of this information can be included in a block or cryptocurrency. Certain or all of this information may be stored, e.g., at content credits server 80. The data can be more valuable as content 89 proceeds through system 5, gathering more data as time goes on. This data can be used to analyze what types of content generate the most income, the best feedback, the best social media engagement, or other types of metrics. This data can also be used to train AI/ML engine 99, or can be analyzed by a previously trained AI/ML engine 99.

It should be understood that AI/ML engine 99 can comprise one or more AI/ML engines. Commonly the terms machine learning engine or machine learning algorithm are used to refer to a specific algorithm. The term artificial intelligence commonly is used to refer to an entire system that achieves intelligence-like outcomes while using multiple sub-systems, such as multiple machine learning algorithms. But both ML and AI have been used to identify a variety of functionalities or types of systems that utilize various combinations of specific ML algorithms. As used herein, AI/ML engine is intended to denote a variety of AI/ML functionalities that fall under the category of AI or ML algorithms and systems that utilize such functionalities. Examples of AI/ML engine 99 can comprise any one or more of e.g.: supervised learning, reinforcement learning, natural language processing such as LLMs, neural networks, computer vision, facial recognition, chatbots, virtual assistants, unsupervised learning, generative AI, other AI or ML models, and/or combinations of any of the foregoing.

In system 5 of FIG. 1, multiple AI/ML engines 9 can be used. For example, one AI/ML engine 99 can comprise a LLM-based chatbot that interacts with any user of system 5 to gauge interests, receive requests or perform other tasks. It may be that multiple different LLMs are used. For example, one LLM might be trained on marketing, economic, or business sources. Another might be trained on customer feedback. A different AI/ML engine may be stored or implemented at various of the components shown in FIG. 1. Alternatively, there may be a smaller number of AI/ML engines 99, and various of the components of FIG. 1 may function as user interfaces for a remote AI/ML engine 99 stored at e.g., content credits server 80. Data used to train, retrain, or implement any of AI/ML engines 99 may be stored at any one or more of the components shown in FIG. 1. A person of ordinary skill in the art will recognize that a variety of such variations are possible under the present disclosure.

The architecture of an AI/ML engine 99 (e.g., structure, number of layers, nodes per layer, activation function etc.) may need to be tailored for each particular use case. For example, properties to vary can include e.g.: consumer characteristic (race, sex, age, etc.), publisher identification, generator identification, length of article, length of video, subject matter of articles/videos, and a variety of other factors. These may all need to be considered when designing an AI/ML engine 99 architecture.

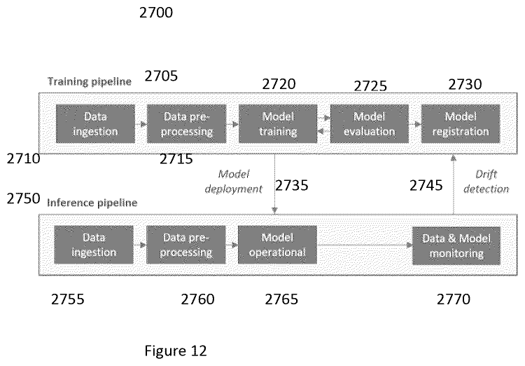

Building an AI/ML engine 99 can include several development steps where the actual training of a ML model or algorithm is just one step in a training pipeline. An important part in AI/ML development is AI/ML model lifecycle management. One version of a model lifecycle management procedure 2700 is illustrated in FIG. 12. The model lifecycle management can in some versions comprise two pipelines: a training pipeline 2705 and an inference pipeline 2750.

At 2710 in the training pipeline 2705, data ingestion 2710 occurs, which includes gathering raw (training) data from a data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model's architecture is fixed, it should be trained on one or more datasets. At 2720 model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model's trainable parameters (e.g., the weights and biases of the underlying neural network (NN)) to minimize a loss function on the training datasets. The loss function may be, for example, based on a maximizing student learning (possibly against a standardized test or other measure); minimizing disruptive behavior; minimizing teacher hours spent on lesson plans, or other metrics. The purpose of the loss function is to meaningfully quantify the reconstruction error for the particular use case at hand. At 2725 model evaluation can be performed where the performance is benchmarked to some baseline. Model training 2720 and evaluation 2725 can be iterated until an acceptable level of performance is achieved. At 2730 model registration occurs, in which the AI/ML model is registered with any corresponding data on how the AI/ML model was developed, and e.g., AI/ML model evaluation data. At 2735 model deployment occurs, wherein the trained/re-trained AI/ML model is implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 is used to process new data received during operation of e.g., system 5 of FIG. 1 or components thereof. At 2770 data and model monitoring is performed. Here the inference data is analyzed to determine whether the inference data are from a distribution that aligns with the training data, as well as monitoring model outputs for detecting any performance, or operational, variance or drifts. The variance or drift is used at 2745 (drift detection) to update the AI/ML model registration.

The training process is typically based on some variant of a gradient descent algorithm, which, at its core, typically comprises three components: a feedforward step, a back propagation step, and a parameter optimization step. These steps can be described using a dense ML model (i.e., a dense NN with a bottleneck layer) as an example.

Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.

Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.

Parameter optimization: The gradients computed in the back propagation step are used to update the ML model's trainable parameters. An approach is to use the gradient descent method with a learning rate hyperparameter (a) that scales the gradients of the weights and biases. It is preferred to make small adjustments to each parameter with the aim of reducing the average loss over the (mini) batch. It is common to use special optimizers to update the ML model's trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) can be repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user.

In some implementations, a function F(·) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware described in system 5 of FIG. 1 (e.g., in the form of simple vector-matrix multiplications).

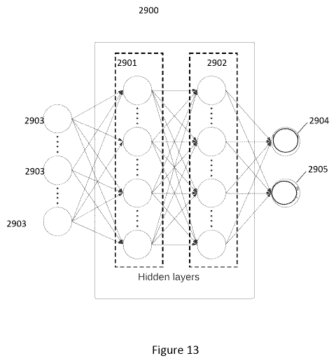

Referring now to FIG. 13, an example NN 2900 (e.g., DNN) is shown. In some implementations, and as shown, the neural network 2900 may include two hidden layers represented by dashed boxes 2901 and 2902. In one implementation, the inputs 2903 may be fed into the NN 2900. Next, the inputs 2403 may go through a set of hidden layers (e.g., 2901 and/or 2902). Once the inputs 2903 pass though the hidden layers 2901 and/or 2902, they may be output (e.g., as an output layer) as outputs 2904, 2905. Outputs 2904, 2905 could be, e.g., customer spend on content, advertiser spend on content, number of views by customers, social media posts mentioning content; or another output valuable. Possible inputs can include e.g.: author/generator identification, subject matter, article/video length, genre (comedy, horror, drama, etc.), or other variables.

As should be understood by one of ordinary skill in the art, in order for the NN 2900 to output proper a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

### Additional Versions

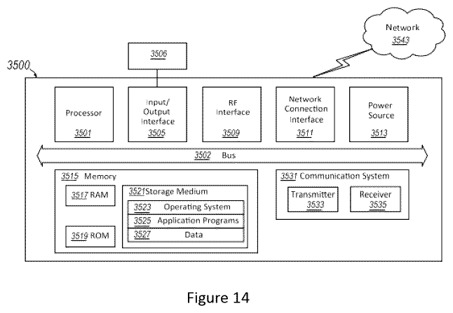

FIG. 14 illustrates a version of various computing devices within system 5 of FIG. 1 or system 500 of FIG. 3, or components thereof e.g., computing devices 45, 55, 65, 75, content server(s) 10, 20, and/or 4 content credit server(s) 80, which can comprise e.g., computers, tablets, servers, databases, mobile devices, or other computing or smart devices described herein. FIG. 14 shows a schematic block diagram of a computing device 3500 (or components thereof) according to certain versions of the present disclosure. System 3500 can be used to analyze and/or optimize: the functionalities described with respect to e.g., computing devices 45, 55, 65, 75, content server(s) 10, 20, and/or 4 content credit server(s) 80, or other computing or smart devices described herein, or to perform other methods, such as DLT, AI or ML-related tasks and analyses as described herein.

Computing device 3500 includes processor 3501 that is operatively coupled via a bus 3502 to an input/output interface 3505, a power source 3513, a memory 3515, a RF interface 3509, network communication interface 3511, and/or any other component, or any combination thereof. The level of integration between the components may vary from one version to another. Further, certain computing devices 3500 (or components thereof) may contain multiple instances of a component, such as multiple processors, memories, transceivers, transmitters, receivers, etc.

The processor 3501 is configured to process instructions and data and may be configured to implement any sequential state machine operative to execute instructions stored as machine-readable computer programs in memory 3515. Processor 3501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 3501 may include multiple central processing units (CPUs).

In the example, input/output interface 3505 may be configured to provide an interface or interfaces to an input/output device(s) 3506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 3500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some versions, the power source 3513 is structured as a battery or battery pack. Other types of power sources, such as an external power source (e.g., an electricity outlet), photovoltaic device, or power cell, may be used. The power source 3513 may further include power circuitry for delivering power from the power source 3513 itself, and/or an external power source, to the various parts of computing device 3500 via input circuitry or an interface such as an electrical power cable.

Memory 3515 may be configured to include memory such as random-access memory (RAM) 3517, read-only memory (ROM) 3519, programmable read-only memory (PROM), erasable programmable read-only memory (EPROM), electrically erasable programmable read-only memory (EEPROM), magnetic disks, optical disks, hard disks, removable cartridges, flash drives, other storage medium 3521, and so forth. In one example, the memory 3515 includes one or more application programs 3525, an operating system 3523, web browser application, a widget, gadget engine, or other application, and corresponding data 3527. Memory 3515 may store, for use by the computing device 3500, any of a variety of various operating systems or combinations of operating systems. An article of manufacture, such as one including a simulation system or communication system may be tangibly embodied as or in memory 2515, which may be or comprise a device-readable storage medium.

Processor 3501 may be configured to communicate with an access network or other network using the RF interface 3509 or network connection interface 3511. The RF interface 3509 or network connection interface 3511 may comprise one or more communication subsystems and may include or be communicatively coupled to an antenna. In the illustrated version, communication functions of the RF interface 3509 or network connection interface 3511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

System 5 of FIG. 1, system 500 of FIG. 3, or computing devices 3500 as described above or in regard to FIG. 1 or FIG. 3, can perform a variety of method versions under the present disclosure. Several example method versions are given below but these examples are non-limiting and are only meant to illustrate certain versions.

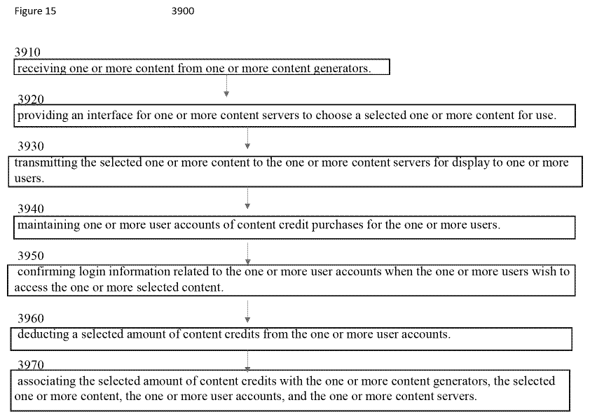

A possible method version under the present disclosure is shown in FIG. 15. Method 3900 comprises a method performed by a content credit system. Step 3910 is receiving one or more content from one or more content generators. Step 3920 is providing an interface for one or more content servers to choose a selected one or more content for use. Step 3930 is transmitting the selected one or more content to the one or more content servers for display to one or more users. Step 3940 is maintaining one or more user accounts of content credit purchases for the one or more users. Step 3950 is confirming login information related to the one or more user accounts when the one or more users wish to access the one or more selected content. Step 3960 is deducting a selected amount of content credits from the one or more user accounts. Step 3970 is associating the selected amount of content credits with the one or more content generators, the selected one or more content, the one or more user accounts, and the one or more content servers. Method 3900 can comprise a variety of additional or alternative steps.

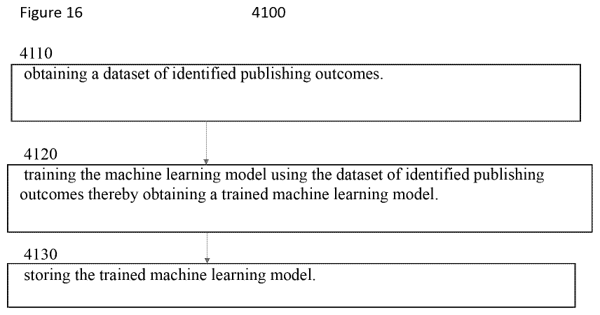

Another possible method version under the present disclosure is shown in FIG. 16. Method 4100 is a computer implemented method for training a machine learning model for optimizing publishing of content. Step 4110 is obtaining a dataset of identified publishing outcomes. Step 4120 is training the machine learning model using the dataset of identified publishing outcomes thereby obtaining a trained machine learning model. Step 4130 is storing the trained machine learning model. Method 4100 can comprise a variety of additional steps or variations.

Although the computing devices described herein (e.g., servers, computing devices, etc. of system 5 of FIG. 1) may include the illustrated combination of hardware components, other versions may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain versions, some or all of the functionality described herein may be provided by processing circuitry executing instructions stored on in memory, which in certain versions may be a computer program product in the form of a non-transitory computer-readable storage medium. In alternative versions, some or all of the functionality may be provided by the processing circuitry without executing instructions stored on a separate or discrete device-readable storage medium, such as in a hard-wired manner. In any of those particular versions, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled-whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary versions may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary versions of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some versions a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more versions or implementations, which are exemplary in nature. As used herein, the term “exemplary” means “serving as an example, instance, or illustration,” and should not necessarily be construed as preferred or advantageous over other versions disclosed herein. In addition, reference to an “implementation” of the present disclosure or versions includes a specific reference to one or more versions thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one version,” “a version,” “an example version,” and the like indicate that the version described may include a particular feature, structure, or characteristic, but it is not necessary that every version includes the particular feature, structure, or characteristic. Moreover, such phrases are not necessarily referring to the same version. Further, when a particular feature, structure, or characteristic is described in connection with a version, it is submitted that it is within the knowledge of one skilled in the art to affect such feature, structure, or characteristic in connection with other versions whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example versions. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary versions of this disclosure may become apparent to those skilled in the relevant arts in view of the foregoing description, when read in conjunction with the accompanying drawings. However, any and all modifications will still fall within the scope of the non-limiting and exemplary versions of this disclosure.

It is understood that for any given component or version described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain versions, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain versions of the present disclosure may include, incorporate, or otherwise comprise properties or features (e.g., components, members, elements, parts, and/or portions) described in other versions disclosed and/or described herein. Accordingly, the various features of certain versions can be compatible with, combined with, included in, and/or incorporated into other versions of the present disclosure. Thus, disclosure of certain features relative to a specific version of the present disclosure should not be construed as limiting application or inclusion of said features to the specific version. Rather, it will be appreciated that other versions can also include said features, members, elements, parts, and/or portions without necessarily departing from the scope of the present disclosure.

Moreover, unless a feature is described as requiring another feature in combination therewith, any feature herein may be combined with any other feature of a same or different version disclosed herein. Furthermore, various well-known aspects of illustrative systems, methods, apparatus, and the like are not described herein in particular detail in order to avoid obscuring aspects of the example versions. Such aspects are, however, also contemplated herein.

It will be apparent to one of ordinary skill in the art that methods, devices, device elements, materials, procedures, and techniques other than those specifically described herein can be applied to the practice of the described versions as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described versions are examples only. Alterations, modifications, and variations may be effected to the particular versions by those of skill in the art without departing from the scope of the description, which is defined solely by the appended claims.

What is claimed is:

1. A content credit system, comprising:
a processor; and
a memory storing instructions whereby the processor is configured to perform the steps of;
receive one or more content from one or more content generators;
provide an interface for one or more content servers to choose a selected one or more content for use;
transmit the selected one or more content to the one or more content servers for display to one or more users;
maintain one or more user accounts of content credit purchases for the one or more users;
confirm login information related to the one or more user accounts when the one or more users wish to access the one or more selected content;
deduct a selected amount of content credits from the one or more user accounts; and
associate the selected amount of content credits with the one or more content generators, the selected one or more content, the one or more user accounts, and the one or more content servers.

2. The system of claim 1, wherein the steps further comprise:
transmit funds to one or more content generators and the one or more content servers based at least in part on the selected amount of content credits.

3. The system of claim 1, wherein the one or more user accounts are each associated with a distributed ledger technology.

4. The system of claim 3, wherein the associating comprises a transaction on the distributed ledger technology.

5. The system of claim 3, wherein the receiving, transmitting, deducting, and associating each comprise a transaction on the distributed ledger technology.

6. The system of claim 1, wherein the steps further comprise:
use an artificial intelligence or machine learning model to analyze the associated selected amount of content credits, one or more content generators, selected one or more content, one or more user accounts, and one or more content servers.

7. The system of claim 1, wherein the steps further comprise: providing an interface for a user to input comments on the selected one or more content.

8. The system of claim 1, wherein the interface is selected from the group consisting of: a mobile application, a browser extension, and a desktop application.

9. A method performed by a content credit system, comprising:
receiving one or more content from one or more content generators;
providing an interface for one or more content servers to choose a selected one or more content for use;
transmitting the selected one or more content to the one or more content servers for display to one or more users;
maintaining one or more user accounts of content credit purchases for the one or more users;
confirming login information related to the one or more user accounts when the one or more users wish to access the one or more selected content;
deducting a selected amount of content credits from the one or more user accounts; and
associating the selected amount of content credits with the one or more content generators, the selected one or more content, the one or more user accounts, and the one or more content servers.

10. The method of claim 9, further comprising:
transmitting funds to one or more content generators and the one or more content servers based at least in part on the selected amount of content credits.

11. The method of claim 9, wherein the one or more user accounts are each associated with a distributed ledger technology.

12. The method of claim 11, wherein the associating comprises a transaction on the distributed ledger technology.

13. The method of claim 11, wherein the receiving, transmitting, deducting, and associating each comprise a transaction on the distributed ledger technology.

14. The method of claim 9, further comprising:
use an artificial intelligence or machine learning model to analyze the associated selected amount of content credits, one or more content generators, selected one or more content, one or more user accounts, and one or more content servers.

15. The method of claim 9, wherein the steps further comprise: providing an interface for a user to input comments on the selected one or more content.

16. The method of claim 8, wherein the interface is selected from the group consisting of: a mobile application, a browser extension, and a desktop application.

17. A method performed by a content credit system, comprising:
detecting one or more content from one or more content generators;
providing an interface for one or more users to input comments on the one or more content independent of a host webpage hosting the one or more content; and
displaying the comments and one or more comments of other users to the user via the interface.

18. The method of claim 17, further comprising:
allowing the user to provide a selected amount of content credits to any of the other users for creation of the one or more comments via the interface;
deducting the selected amount of content credits from a user account of the user; and
associating the selected amount of content credits with the other users.

19. The method of claim 17, wherein the interface is selected from the group consisting of: a mobile application, a browser extension, and a desktop application.

20. The method of claim 17, further comprising, prior to providing an interface for one or more users to input comments, deducting an amount of content credits from one or more corresponding user accounts.
